(19) United States
(12) Patent Application Publication
(10) Pub. No.: US 2007/0232280 A1
(43) Pub. Date: Oct. 4, 2007

(54) Method for Setting up a Link with Prepaging While Optimizing Use of Resources

(76) Inventors: Jurgen Pruser, Bad Hersfeld (DE); Norbert Vogelsberg, Freilendorf (DE); Ulrich Wiehe, Bad Hersfeld (DE)

Correspondence Address: STAAS & HALSEY LLP, SUITE 700, 1201 NEW YORK AVENUE, N.W., WASHINGTON, DC, 20005, US

(21) Appl. No.: 11/587,813

(22) PCT Filed: Apr. 26, 2005
(86) PCT No.: PCT/EP05/51871

§ 371 Date: Oct. 27, 2006

(30) Foreign Application Priority Data
Apr. 27, 2004 (DE) 10 2004 020 535.3

(51) Int. Cl. H04Q 7/38

(52) U.S. Cl. 455/414.1

(57) ABSTRACT

A method sets up a link with pre-paging to a called subscriber mobile terminal in a mobile radiotelephone network. A gateway telephone exchange sends a release instruction to the visitor subscriber database of the visited telephone exchange if the gateway telephone exchange has received from the calling mobile terminal, in the time interval since the transmission of the routing request, a message indicating that the setting up of the link is interrupted. On receiving that release instruction, a temporary identification reserved by routing, of resources associated to said identification as well as the resources booked by the search, for the interface between the telephone exchange and the radio subsystem, are released.

### CROSS REFERENCE TO RELATED APPLICATIONS

This application is based on and hereby claims priority to PCT National Phase Application No. PCT/EP2005/051871 filed on Apr. 26, 2005 and German Application No. 10 2004 020 535.3 filed on Apr. 27, 2004, the contents of which are hereby incorporated by reference.

### BACKGROUND

The invention relates to a method for setting up a link with pre-paging to a mobile terminal.

To set up a link to a called mobile terminal the switching center must know the current radio cell of the terminal, and a paging message for the terminal is sent in order to request the current status of the terminal. This paging enables the resources for setting up the link to be reserved at the interface between switching center and radio subsystem and makes it possible to determine that it is not possible to set up a link at the current time, maybe because the terminal is switched off or is outside the area of a radio cell

Before the paging in GSM/UMTS networks the process of starting a call path by reserving the resources belonging to an MSRN (Mobile Station Roaming Number) is usually undertaken. This routing through the switching network is referred to as the SRI/PRN procedure and will now be described in greater detail with reference to FIG. 3.

The connection request by the calling subscriber reaches a GMSC (Gateway Mobile Services Switching Center) which is connected to the calling subscriber's network in the form of an IAM (Initial Address Messaging) message. On receiving this message, the GMSC attempts routing to the visited switching center (MSC, Mobile Services Switching Center) in the area of responsibility of which the called terminal is located.

To this end the GMSC sends a routing request SRI (Send Routing information) to an HLR (Home Location Register) in which items such as a reference to the visited switching center MSC of the called subscriber are stored. The HLR then transmits a reservation request for an MSRN to a VLR (Visitor Location Register) of the MSC, in which a copy of the user data of all visiting subscribers is stored.

The MSC/VLR now assigns the request of the HLR to an MSRN and sends it back to the HLR. At the same time a timer is started so that, after 90 seconds has elapsed, the resources are released again provided the returned MSRN is not used within this period. After the HLR has received the acknowledgement message PRN ack it transfers for its part an acknowledgment message SRI ack to the GMSC to indicate to the latter the successful conclusion of the routing.

If, as shown in the example in FIG. 3, in the period indicated by the grey rectangle between routing request SRI and routing acknowledgement SRI ack, the GMSC receives a release message from the network of the calling subscriber because the calling subscriber has gone on-hook in the meantime, the timer in the VLR times out and the resources can be released.

However it can now be the case that the entire connection path has been reserved completely unnecessarily because the called terminal is not available at all. What is known as pre-paging was proposed as a way out, said method being described in the Technical Report on Pre-Paging of the 3GPP, TR 23.908. The pre-paging mechanism will now be described in greater detail in conjunction with FIG. 4.

The message flow resulting from the connection request from a calling subscriber via the GMSC, the HLR and the VLR does not change in this case. Instead however of the VLR directly returning the acknowledgment message PRN ack, paging is started while the routing process is still underway. To this end a paging request PAGE is sent to the MSC. The MSC then executes a paging i.e. it transfers on the paging channel a paging message into all radio cells of that area (Location Area) in which, according to the Location Area Code stored in the VLR, the called terminal is located. When the terminal has responded with a status message, the MSC knows the current radio cell of the terminal and sends a paging response message PAR back to the VLR. The further message flow then again corresponds to the SRI/PRN procedure without pre-paging.

FIG. 4 shows the message flow in the case of success, that is when the called terminal responds to the paging. If the called terminal does not respond to the paging, no MSRN needs to be reserved and kept available for 90 seconds in this case. This enables the resources in the switching network to be preserved.

As can be seen from FIGS. 3 and 4 however, the pre-paging extends the interval between sending the SRI and receipt of SRI ack by the introduction of pre-paging (from around 1 second to several seconds). However this also increases the probability that a release message will be received in this time window. This case occurs if the calling subscriber goes on-hook shortly after dialing the complete number of the called mobile radio subscriber. Furthermore it is clear that with the introduction of pre-paging in this now more probable case not only the MSRN, but also resources in the MSC/VLR are unnecessarily occupied at the interface to the radio subsystem.

### SUMMARY

One possible object of the invention is thus to avoid the unnecessary resource occupation caused by the introduction of pre-paging.

The solution in this case uses the principle of using the release message of the calling subscriber received in the GMSC as its starting point in order to avoid an unnecessary allocation of resources With the aid of this information the guard period of 90 seconds for which the MSC waits for resources to be used can be shortened to the time interval actually needed. By forwarding the release message from the GMSC to the VLR the resources can be released immediately as soon as it is clear that they are no longer needed.

The advantage of the method is that a pre-paging without the disadvantages described above can be used. This means that not only the MSRN and the resources connected with it are released quickly but also the resources occupied by the pre-paging

Advantageously the release instruction is routed in this case with a temporary identifier. On the one hand this method makes it abundantly clear which resources will be released. On the other hand the known routing path can be used.

Preferably the mobile radio network is a GSM network or an UMTS network. In both networks the paging mechanism described is a fixed component so that it can profit especially from the proposed expansion of the pre-paging mechanism.

### BRIEF DESCRIPTION OF THE DRAWINGS

These and other objects and advantages will become more apparent and more readily appreciated from the following description of the preferred embodiments, taken in conjunction with the accompanying drawings of which:

FIG. 1 is a mobile radio network with a switching center according to one embodiment of the invention;

FIG. 2 is a message flow diagram with optimized pre-paging according to one embodiment of the invention;

FIG. 3 is the message flow diagram without pre-paging in a known mobile radio network; and

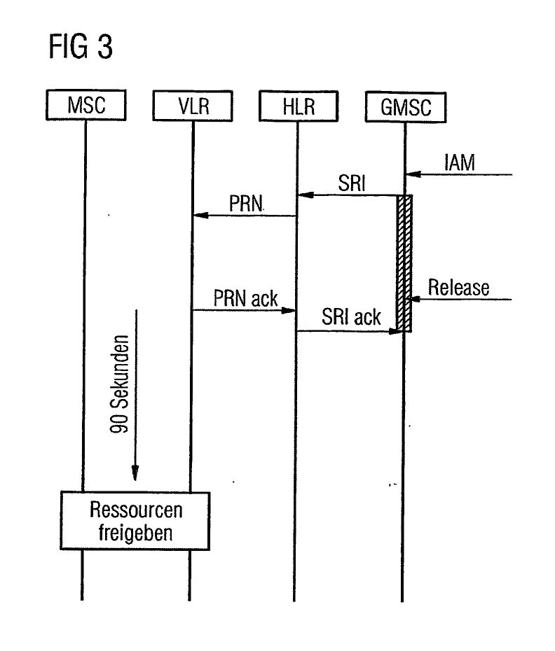

FIG. 4 is the message flow diagram with pre-paging in a known mobile radio network.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

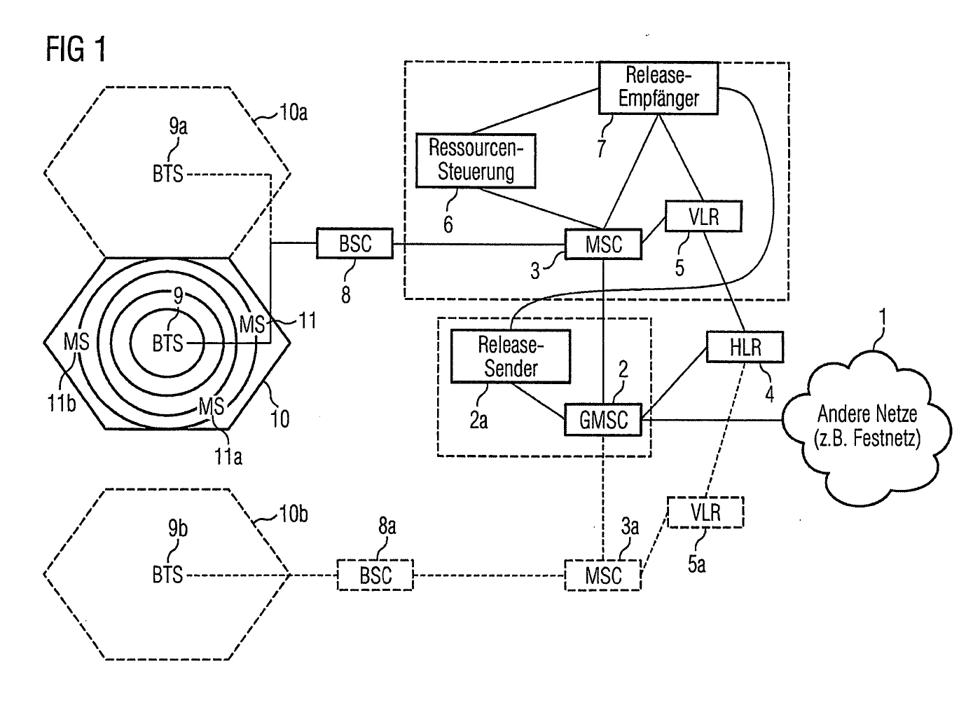

FIG. 1 shows a schematic diagram of the layout of a mobile radio network with switching centers. The mobile radio network is connected to another network 1, for example a fixed network, via a gateway mobile switching center GMSC 2. The GMSC 2 is thereby the central gateway to other telecommunications networks. It features a release transmitter 2a connected to it which can send a release message Release Resources. The GMSC 2 is connected to further switching centers MSC 3, 3a. In his case only one of the further switching centers MSC 3 is to be described in greater detail, whereas further switching centers MSC 3a and devices assigned to these further switching centers MSC 3a are only shown by a dashed outline and are not described in any greater detail below.

The GMSC 2 has access to all user data of the mobile radio network through a connection to the home location register HLR 4. The HLR 4 for its part is connected to visitor location registers VLR 5, 5a of the visited switching centers MSC 3, 3a. The VLR holds a copy of the relevant user data from the HLR for those mobile subscribers whose terminals are currently located in the area of responsibility of MSC 3.

The MSC 3 features a resource controller 6 which can reserve the resources for a connection and release them again. On the one hand this includes the MSRN with associated resources, which defines the call path within the switching network 2, 3, 4, 5, and on the other hand the resources which are reserved using paging. The resource controller 6 is a connected to the MSC 3 and to a release receiver 7 which can receive the Release Resources message of the release transmitter 2a. The release receiver 7 is additionally connected to the MSC 3 and the VLR 5. This enables a Release Resources message to reach all units of the MSC.

Each MSC 3, 3a is connected to one or more base station controllers (BSC) 8 for one or more base transceiver stations (BTS) 9, 9a, 9b in each case for an associated radio cell 10, 10a, 10b. The BTS 9 supplies its radio cell 10 with the necessary radio signals and receives corresponding radio signals from mobile stations MS 11, 11a, 11b.

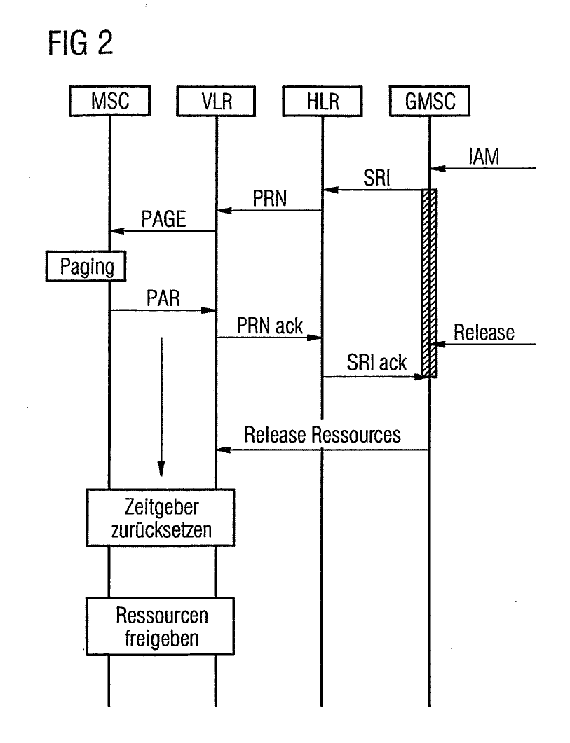

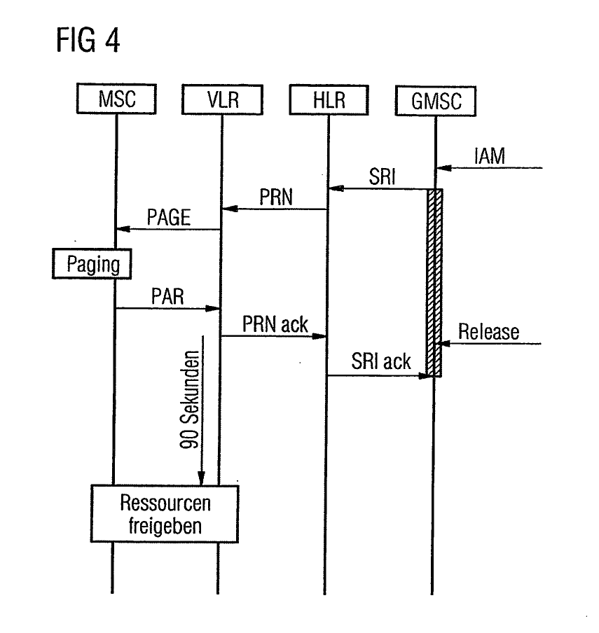

The message flow in a mobile radio network as depicted in FIG. 1 will now be presented with a reference to the FIG. 2. This message flow does not differ in the first part, namely the SRI/PRN procedure and the pre-paging, from the message flow described in the introduction and with reference to FIG. 4.

A calling subscriber from a telecommunications network 1 dials a complete mobile radio number to set up a connection to the mobile station 11 of a called subscriber. The GMSC 2 receives the corresponding IAM message. It then sends a first routing request SRI to the home location register HLR 4 to set up the call path through the switching network. On receipt of the SRI message the HLR 4 then sends a request for allocation of an MSRN by a PRN message to the VLR 5. The information about the VLR 5 to be accessed is stored in the HLR 4.

The VLR 5 of the visited MSC 3 then sends the paging message PAGE to the MSC 3 which uses paging to search for contact with the mobile station 11. To this end the paging message is sent via the BSC 8 to the base station BTS 9. Here the drawing makes the assumption, to simplify matters, that the location area of the mobile station 11, stored as the location area code held in the VLR 5, is already covered by the radio cell 10. Usually a Location Area comprises a plurality of radio cells. The BTS 9 sends the paging message by radio into the radio cell 10 which represents the Location Area, and thus also to the mobile station 11. In its turn the outgoing acknowledgement message from the station 11 reaches the MSC 3 on the same path after the completion of paging. The resources for the desired connection on the interface between MSC 3 and BSC 8 are also reserved by the paging.

The MSC 3 sends a message PAR about the successful paging to the VLR 5. In the VLR 5 a timer is started at this point in time. This timer waits for a defined time, for example 90 seconds, in which it keeps the resources for the desired connection setup free. After this time elapses the resources are released again. The VLR 5 sends a message PRN ack to the HLR 4, whereby the message also contains the allocated MSRN. The HLR 4 for its part sends an acknowledgement message SRI ack to the GMSC 2 and in doing so transfers the MSRN. This concludes the RSI/PRN procedure and the pre-paging.

If the GMSC 2 now receives, in the time since the transmission of the first routing request SRI, a release message Release from the telecommunications network 1 of the calling subscriber, that is within the time indicated by the gray block, then it is already clear at this point that the reserved resources will not be used. Instead of also waiting until the timer in the VLR 5 times out, the GMSC 2 via its release transmitter 2a sends a Release Resources message to the VLR 5 or to the release receiver 7 in the MSC 3. The release receiver 7 informs the resource controller 6 about the entry of the Release Resources message. The resource controller 6 can then release the MSRN, its associated resources within the switching network 2, 4, 5 and the resources reserved during the paging process.

This method and the additional Release Resources message allow resources no longer needed to be reliably released for a link setup aborted by the calling subscriber. In particular it is not necessary to wait for the timer to time out. This means that the advantages of pre-paging, namely that no resources within the switching network 2, 3, 5 are unnecessarily reserved when the called mobile station cannot be reached at all, are used, without the disadvantage associated with pre-paging that resources are reserved during paging which are then unnecessarily blocked until the timer times out.

Thus, despite introduction of pre-paging, the disadvantage otherwise associated with pre-paging of unnecessary resource reservation which is more probable because of extension of the time window between SRI and SRI ack and more comprehensive because of the additional resources reserved are avoided with the method.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-7. (canceled)

8. A method for setting up a link with pre-paging to a mobile station of a called subscriber in a mobile radio network, the mobile station being at a visited radio cell associated with a visited switching center, the method comprising the following performed in the order listed:
receiving an Initial Address Message of a calling subscriber from a telecommunications network through a gateway switching center, whereby the Initial Address Message contains information about the called subscriber;
sending a service request from the gateway switching center to a home location register, the service request containing the information about the called subscriber and identifying the visited switching center;
sending a routing request to request that a temporary identifier be allocated to the called subscriber, the routing request being sent from the home location register to a visitor location register associated with the visited switching center;
sending a paging request from the visitor location register to the visited switching center;
paging, by the visited switching center sending a paging message for the mobile station of the called subscriber into the visited radio cell, and reserving the temporary identifier, and resources necessary to set up the link, for the called subscriber; and
sending response messages to respond respectively to the page request, the routing request and finally the service request, the temporary identifier being identified in the response messages responding to the routing request and the service request; wherein
if the gateway switching center receives an abort message in a time interval between sending the service request and receiving the response message, the gateway switching center sends a release allocation message to the visitor location register associated with the visited switching center, and
upon receiving the release allocation message, the temporary identifier and the resources necessary to set up the link are released.

9. The method as claimed in claim 8, wherein,
the release allocation message from the gateway switching center to the visitor location register associated the visited switching center identifies the temporary identifier.

10. The method as claimed in claim 8, wherein,
the mobile radio network is a GSM network or a UMTS network.

11. The method as claimed in claim 9, wherein,
the mobile radio network is a GSM network or a UMTS network.

12. A switching center in a mobile radio network for setting up calls with pre-paging, comprising:
a visitor location register to receive a routing request from a home location register connected to the switching center, to send a paging request message and to send an acknowledgement in response to the routing request;
a paging device to receive the paging request, to page a called party and to reserve a temporary identifier and network resources for the call;
a release receiving device to receive a release instruction requesting release of the temporary identifier; and
a resource controller connected to the release receiving device to release the temporary identifier upon receipt of the release instruction, and to release the network resources reserved for the call.

13. A gateway switching center in a mobile radio network for switching a call with pre-paging to a called party, comprising:
a transmitter to transmit a routing request to a home location register; and
a receiver to receive an acknowledgement in response to the routing request, the acknowledgement identifying a temporary identifier assigned to the call; and
a release transmitter device, to transmit a release message to request release of the temporary identifier, the release message being transmitted to a visited switching center associated with a current location of the called party.

14. A mobile radio network to set up a call to a called party, the network comprising:
a gateway switching center to:
to transmit a routing request,
to receive an acknowledgement in response to the routing request, the acknowledgement identifying a temporary identifier assigned to the call, and
to transmit a release message to request release of the temporary identifier, the release message being transmitted if the acknowledgement has not yet been received, a visited switching center comprising:
a visitor location register to receive the routing request, to send a paging request message and to send the acknowledgement in response to the routing request;
a paging device to receive the paging request, to page a called party and to reserve the temporary identifier and network resources for the call;
a release receiving device to receive the release message; and
a resource controller connected to the release receiving device to release the temporary identifier upon receipt of the release message and to release the network resources reserved for the call.

15. The mobile radio network as claimed in claim 14, wherein the mobile radio network is a GSM network or a UMTS network.
